(19) United States
(12) Patent Application Publication
(10) Pub. No.: US 2025/0244600 A1
(43) Pub. Date: Jul. 31, 2025

(54) Reticle Adjusting Device of Inner Red Dot Sight, and Sight

(71) Applicant: Nextorch Industries Co., Ltd., Yangjiang (CN)

(72) Inventors: Jingxiang WU, Yangjiang (CN); Bing LIANG, Yangjiang (CN)

(21) Appl. No.: 18/928,003

(22) Filed: Oct. 26, 2024

(30) Foreign Application Priority Data
Jan. 25, 2024 (CN) 202410112883.9

(51) Int. Cl. G02B 27/36

(52) U.S. Cl. CPC G02B 27/36

(57) ABSTRACT

A reticle adjusting device includes a light source mounting seat; a UP adjusting mechanism which is connected with or abuts against a bottom of the light source mounting seat and is used for adjusting the light source mounting seat to move upwards in a vertical direction; a UP resetting mechanism which is movably connected with the light source mounting seat in an inserted mode and is used for enabling the light source mounting seat to move downwards to be reset in the vertical direction; an R adjusting mechanism is used for adjusting the light source mounting seat to move leftwards or rightwards in a horizontal direction; and an R resetting mechanism is used for resetting the light source mounting seat rightwards or leftwards in the horizontal direction, wherein the R adjusting mechanism and the R resetting mechanism are arranged at two ends of the light source mounting seat respectively.

### CROSS-REFERENCE TO RELATED APPLICATIONS

This application claims priority to Chinese Patent Application No. 202410112883.9, filed on Jan. 25, 2024, which is incorporated herein by reference in its entirety.

### TECHNICAL FIELD

The present disclosure relates to the technical field of inner red dot sights, more specifically to a reticle adjusting device of an inner red dot sight, and the sight.

### BACKGROUND OF THE INVENTION

With the development of inner red dot sights, a shape of a reticle no longer requires a use of an aperture for imaging, but is achieved directly by encapsulating a shape of an LED. LED chips of existing inner red dot sights are all mounted inside a cavity at a rear end of an optical system, and an adjustment of a position of an LED chip mounting seat is achieved by vertically or horizontally adjusting screws, thereby achieving an adjustment of a sight reticle. However, during an adjustment process, a clearance of thread fit of a screw often needs to be adjusted due to a mutual interference of springs. The clearance in the cavity space causes the mounting seat to tilt during a single direction adjustment or causes the mounting seat to jump during shooting, so that the reticle adjusting precision and efficiency are relatively low.

### SUMMARY OF THE INVENTION

The present disclosure aims to overcome the problem that an inner red dot sight is relatively low in reticle adjusting precision and efficiency, and provides a reticle adjusting device of an inner red dot sight, which is able to improve the reticle adjusting precision and efficiency.

In order to achieve the above objectives, the present disclosure adopts the following technical solution:

A reticle adjusting device of an inner red dot sight includes a light source mounting seat; at least one UP adjusting mechanism which is connected with or abuts against a bottom of the light source mounting seat and is used for adjusting the light source mounting seat to move upwards in a vertical direction; a UP resetting mechanism which is movably connected with the light source mounting seat in an inserted mode and is used for enabling the light source mounting seat to move downwards to be reset in the vertical direction; an R adjusting mechanism which is connected with the light source mounting seat and is used for adjusting the light source mounting seat to move leftwards or rightwards in a horizontal direction; and an R resetting mechanism which is connected with the light source mounting seat and is used for enabling the light source mounting scat to move rightwards or leftwards to be reset in the horizontal direction, wherein the R adjusting mechanism and the R resetting mechanism are arranged at two ends of the light source mounting seat respectively.

The light source mounting seat in the present disclosure is used for mounting a light source, and the adjustment of sight reticle is able to be achieved by adjusting upper, lower, left and right positions of the light source mounting seat. The UP adjusting mechanism is able to move in the vertical direction, the UP adjusting mechanism is able to be used for driving the light source mounting seat to move upwards, the UP resetting mechanism is able to be used for resisting an upward movement of the light source mounting seat, and the UP resetting mechanism is able to be used for driving the light source mounting seat to move downwards to be reset. A function of the R adjusting mechanism is similar to a function of the UP adjusting mechanism, but the R adjusting mechanism is arranged on the left side or right side of the light source mounting seat to drive the light source mounting seat to move in the horizontal direction. A function of the R resetting mechanism is similar to a function of the UP resetting mechanism, but the R resetting mechanism is arranged on the other side of the R adjusting mechanism relative to the light source mounting seat to resist the relative horizontal movement of the light source mounting seat under an action of the R adjusting mechanism, so that the light source mounting seat is able to be horizontally reset. In some embodiments, when the R adjusting mechanism is arranged on the left side of the light source mounting seat, the R resetting mechanism is arranged on the right side of the light source mounting seat. The inventive point of the present disclosure is that regardless of whether the light source mounting seat actively adjusts the position in the vertical direction under the action of the UP adjusting mechanism or passively deviates in the vertical direction under the action of the R adjusting mechanism and the R resetting mechanism, the UP resetting mechanism is able to ensure that the light source mounting seat does not jump in the vertical direction. Similarly, the R resetting mechanism is also able to ensure that the light source mounting seat does not jump in the horizontal direction when the light source mounting seat actively adjusts the position in the horizontal direction or passively deviates in the horizontal direction, thereby improving the reticle adjusting precision and efficiency.

In some embodiments, a first limiting part is arranged at an end of the R adjusting mechanism, a second limiting part and a third limiting part are arranged at the two ends of the light source mounting seat respectively, a fourth limiting part is arranged at an end of the R resetting mechanism, the first limiting part and the second limiting part are limited in an abutting mode, and the third limiting part and the fourth limiting part are limited in an abutting mode. The first limiting part is matched with the second limiting part, and the third limiting part is matched with the fourth limiting part to together achieve guide limiting when the R adjusting mechanism drives the light source mounting seat to move in the horizontal direction, thereby preventing the position of the light source mounting seat from deviating from an original direction.

In some embodiments, the second limiting part and the third limiting part are both protrusions, and the first limiting part and the fourth limiting part are both grooves matched with the protrusions. In some embodiments, the protrusions and the grooves both have arc-shaped structures, the second limiting part and the third limiting part are symmetrically arranged about a geometric center of the light source mounting seat, and a size of the second limiting part is the same as a size of the third limiting part.

In some embodiments, the R adjusting mechanism includes an R adjusting screw and an R adjusting slider, the R adjusting screw is horizontally arranged and is in threaded connection with the R adjusting slider, and the first limiting part is located on the R adjusting slider. By rotating the R adjusting screw, the R adjusting slider is able to slide left and right along the horizontal direction, thereby achieving the reticle adjusting of the light source in the horizontal direction.

In some embodiments, the R resetting mechanism includes an R resetting slider and two R resetting units which are symmetrically arranged on two sides of a horizontal central axis of the R resetting slider, each of the two R resetting units includes at least one R resetting spring and at least one R resetting spring sleeve, the at least one R resetting spring sleeve sleeves an end of the at least one R resetting spring, and the at least one R resetting spring is horizontally arranged on the R resetting slider. The R resetting slider is in direct contact with the R resetting spring and the R resetting spring sleeve. Under the action of the R resetting spring, the R resetting slider provides a resetting pressure to a direction that resists a movement of the R adjusting mechanism. Furthermore, under the protection of the R resetting spring sleeves, mutual interference between the R resetting springs during squeezing is able to be prevented, thereby preventing the adjusting precision and efficiency from being affected.

In some embodiments, each of the at least one UP adjusting mechanism includes a UP adjusting screw, at least one bias mechanism and a UP adjusting slider, the UP adjusting screw is vertically arranged and is in threaded connection with the UP adjusting slider, the at least one bias mechanism is perpendicular to the UP adjusting screw, and the at least one bias mechanism is movably disposed in the UP adjusting slider in a penetrating manner. The UP adjusting screw is connected with the UP adjusting slider through threads. By rotating the UP adjusting screw, the UP adjusting slider is able to slide up and down. The bias mechanism is perpendicular to a movement direction of the UP adjusting slider, so that when the UP adjusting slider slides up and down, a parallel state is able to be maintained; and when the recoil force generated by an emitter causes a deviation of the light source mounting seat of the sight, the light source mounting seat is reset.

In some embodiments, the UP adjusting screw includes an adjusting seat, an adjusting screw rod, an elastic connecting piece and a gasket, the adjusting seat sleeves an outside of the adjusting screw rod, the elastic connecting piece is penetrated between the adjusting seat and the adjusting screw rod, and the gasket sleeves the adjusting screw rod, wherein the elastic connecting piece includes a limiting nail and a limiting spring which are connected with each other, the limiting nail and the limiting spring are both mounted in the mounting hole of the adjusting screw rod, and then, the adjusting seat is sleeved. A latch groove is designed inside the adjusting seat, the limiting nail is provided with a latch, and the latch is clamped with the latch groove to prevent a relative rotation between the adjusting screw rod and the adjusting seat, thereby avoiding the relative rotation between the adjusting screw rod and the adjusting seat, which may affect the aiming precision, when an emitter vibrates, impacts or falls.

In some embodiments, the bias mechanism is one of a spring, a rubber elastomer and an elastic bead. By an own elastic recovery force, the bias mechanism is able to prevent the deviation of the light source mounting seat in the horizontal direction when the UP adjusting screw drives the UP adjusting slider to move up and down.

In some embodiments, the UP resetting mechanism includes two UP resetting units which are symmetrically arranged on two sides of a longitudinal central axis of the light source mounting seat, each of the two UP resetting units includes at least one UP spring sleeve and at least one UP resetting spring, the at least one UP spring sleeve sleeves an end of the at least one UP resetting spring correspondingly, and the at least one UP resetting spring is vertically arranged on the light source mounting seat. The UP resetting mechanism is able to apply a downward pressure under the action of the UP resetting spring to reset the light source mounting seat. Furthermore, under the protection of the UP spring sleeves, mutual interference between the UP resetting springs during squeezing is able to be prevented, thereby preventing the adjusting precision and efficiency from being affected.

In some embodiments, the second limiting part and the third limiting part are symmetrically arranged at the two ends of the light source mounting seat, the second limiting part and the third limiting part are respectively provided with a mounting hole, two UP adjusting mechanisms are provided, and the two UP adjusting mechanisms are connected with the light source mounting seat in an inserted mode through the mounting hole. By symmetrically arranging the UP adjusting mechanisms, when the position of the light source mounting seat in the vertical direction is adjusted, the force is more balanced, so that the movement trajectory is more straight, and the deviation is not easy to occur.

The present disclosure further provides a sight, including a housing, and an optical lens, a light source, a switch assembly, a circuit driving assembly and the reticle adjusting device as described above, which are arranged on the housing, wherein the optical lens is located at a front of the housing, the light source is arranged in the reticle adjusting device, the circuit driving assembly is connected with the switch assembly, and the switch assembly is also electrically connected with the light source. In some embodiments, the light source is mounted on the light source mounting seat in the reticle adjusting device. After the light source is turned on, a reticle shape of a sight is formed and is reflected in parallel by the optical lens to enter the human eye, and at the same time, the human eye sees a target through the optical lens. The reticle adjusting device is used for adjusting the light source mounting seat so as to adjust the position of the light source. When the reticle shape is overlapped with the target, the aiming is completed.

The present disclosure has the following beneficial effects:
(1) The UP spring sleeve and the R resetting spring sleeve are used for protecting the UP resetting spring and the R resetting spring during the movement of the light source mounting seat to prevent deformation and interference. The bias mechanism is able to keep the UP adjusting slider parallel during movement, and reset the light source mounting seat when the recoil force generated by the emitter causes the deviation of the light source mounting seat. The adjusting precision and efficiency of sight reticle are improved by the above measures.
(2) The light source mounting seat is assembled between the R adjusting mechanism and the R resetting mechanism. By rotating the UP adjusting screw, the UP adjusting slider is able to slide up and down. With the cooperation of the UP resetting mechanism, when the light source mounting seat is able to slide up and down between the R adjusting mechanism and the R resetting mechanism, the first limiting part is matched with the second limiting part, and the third limiting part is matched with the fourth limiting part to achieve a limiting function, so that the light source mounting seat is able to be guided during the movement to prevent the light source mounting seat from moving back and forth. By rotating the R adjusting screw, the R adjusting slider is able to slide left and right. With the cooperation of the R resetting mechanism, the light source mounting seat and the UP resetting mechanism are able to slide left and right in the horizontal direction together with the R adjusting mechanism and the R resetting mechanism. One end of the UP spring sleeve in the UP resetting mechanism is provided with a ball head surface, and a smooth ball head contact surface is able to provide less friction resistance, so that the light source mounting seat is easier to slide left and right, the R resetting springs are protected and prevented from mutual interference caused by deformation and squeezing when moving left and right, and the adjusting precision and efficiency are improved.

### BRIEF DESCRIPTION OF DRAWINGS

FIG. 1 is an exploded structural view of a reticle adjusting device of an inner red dot sight in the present disclosure.

FIG. 2 is an exploded structural view of a UP adjusting mechanism in the present disclosure.

FIG. 3 is a structural view of a UP adjusting mechanism in the present disclosure.

FIG. 4 is a cross-sectional view along A-A in FIG. 3.

FIG. 5 is an exploded structural view of a UP adjusting screw in the present disclosure.

FIG. 6 is a structural view of a UP adjusting screw in the present disclosure.

FIG. 7 is a cross-sectional view along B-B in FIG. 6.

FIG. 8 is an exploded structural view of an R adjusting mechanism in the present disclosure.

FIG. 9 is a structural view of an R adjusting mechanism in the present disclosure.

FIG. 10 is a cross-sectional view along C-C in FIG. 9.

FIG. 11 is an exploded structural view of an R resetting mechanism in the present disclosure.

FIG. 12 is a structural view of an R resetting mechanism in the present disclosure.

FIG. 13 is a cross-sectional view along D-D in FIG. 12.

FIG. 14 is an exploded structural view of a UP resetting mechanism and a light source mounting seat in the present disclosure.

FIG. 15 is a structural view of a UP resetting mechanism and a light source mounting seat in the present disclosure.

FIG. 16 is a cross-sectional view along E-E in FIG. 15.

FIG. 17 is a structural view of a sight in a first direction in the present disclosure.

FIG. 18 is a structural view of a sight in a second direction in the present disclosure.

FIG. 19 is a cross-sectional view along F-F in FIG. 18.

FIG. 20 is an exploded structural view of a sight in the present disclosure.

Description of reference numerals:

1. UP adjusting mechanism; 11. UP adjusting screw; 111. adjusting seat; 112. limiting nail; 113. limiting spring; 114. adjusting screw rod; 115. gasket; 12. bias mechanism; 13. UP adjusting slider; 2. UP resetting mechanism; 21. UP spring sleeve; 22. UP resetting spring; 3. R adjusting mechanism; 31. R adjusting screw; 32. R adjusting slider; 4. R resetting mechanism; 41. R resetting slider; 42. R resetting spring; 43. R resetting spring sleeve; 5. light source mounting seat; 61. first limiting part; 62. second limiting part; 63. third limiting part; 64. fourth limiting part; 1001. housing; 1002. optical lens; 1003. switch assembly; 1004. circuit driving assembly; 1005. reticle adjusting device; 1006. light source.

### DETAILED DESCRIPTION OF THE INVENTION

The accompanying drawings are for illustrative purposes only and should not be construed as limiting this patent. In order to better illustrate this embodiment, some components in the accompanying drawings may be omitted, enlarged or reduced, and do not represent the actual sizes of products. For those skilled in the art, it can be understood that some well-known structures and explanations thereof may be omitted in the accompanying drawings. The description of the position relationship in the accompanying drawings is for illustrative purposes only and should not be construed as limiting this patent.

The same or similar reference numerals in the accompanying drawings of the embodiments of the present disclosure correspond to the same or similar components. In the description of the present disclosure, it should be understood that if there are terms such as “up”, “down”, “left”, “right”, “long” and “short” indicating orientation or position relationships based on the orientation or position relationships shown in the accompanying drawings, the terms are only for the convenience of describing the present disclosure and simplifying the description, rather than indicating or implying that the mentioned device or component needs to have a specific orientation or needs to be constructed and operated in a specific orientation. Therefore, the terms for describing the position relationships in the accompanying drawings are for illustrative purposes only and should not be construed as limiting this patent. For those of ordinary skill in the art, the specific meanings of the above terms may be understood according to specific situations.

The technical solution of the present disclosure will be further specifically described below according to specific embodiments with reference to the accompanying drawings.

### Embodiment 1

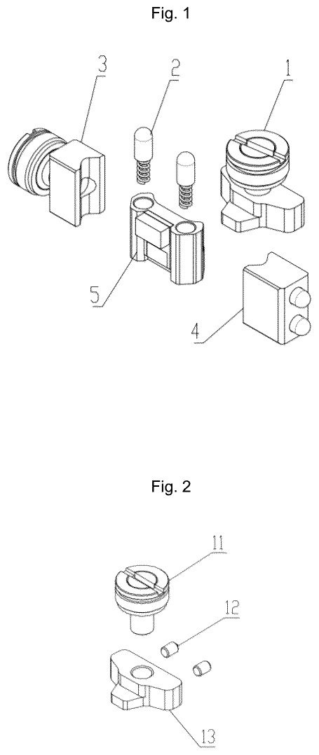

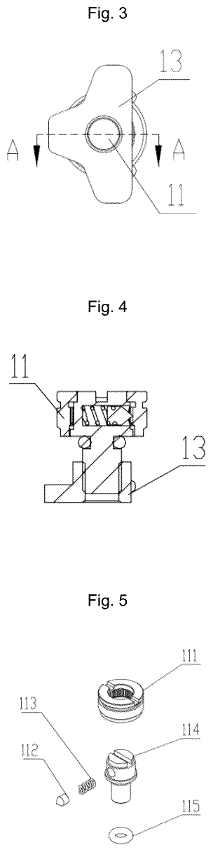

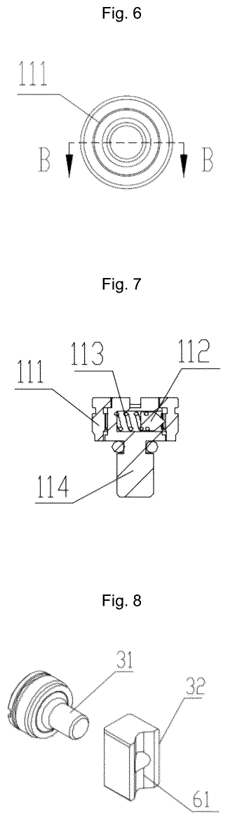

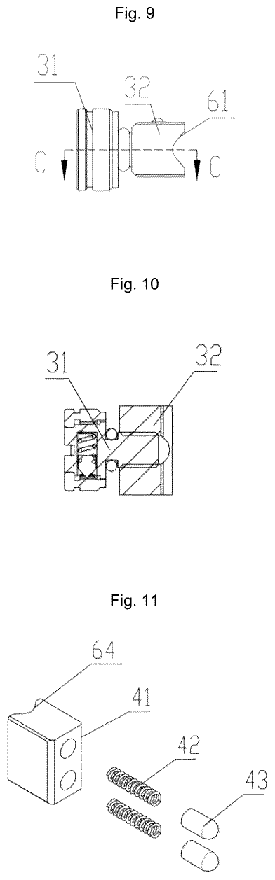

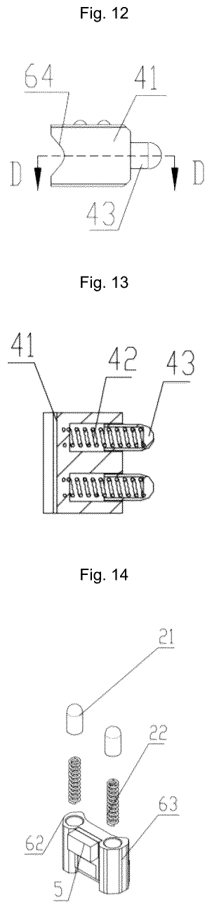

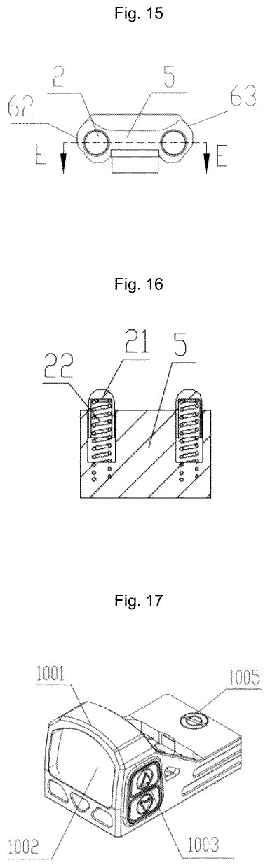

FIG. 1 to FIG. 16 show an embodiment 1 of a reticle adjusting device of an inner red dot sight in the present disclosure. The reticle adjusting device of the inner red dot sight includes a light source mounting seat 5, at least one UP adjusting mechanism 1, a UP resetting mechanism 2, an R adjusting mechanism 3 and an R resetting mechanism 4, wherein the UP adjusting mechanism 1 is connected with or abuts against a bottom of the light source mounting seat 5 and is used for adjusting the light source mounting seat 5 to move upwards in a vertical direction; the UP resetting mechanism 2 is movably connected with the light source mounting seat 5 in an inserted mode and is used for enabling the light source mounting seat 5 to move downwards to be reset in the vertical direction; the R adjusting mechanism 3 is connected with the light source mounting seat 5 and is used for adjusting the light source mounting seat 5 to move leftwards or rightwards in a horizontal direction; the R resetting mechanism 4 is connected with the light source mounting seat 5 and is used for enabling the light source mounting seat 5 to move rightwards or leftwards to be reset in the horizontal direction; and the R adjusting mechanism 3 and the R resetting mechanism 4 are arranged at two ends of the light source mounting seat 5 respectively.

The light source mounting seat 5 in the present disclosure is used for mounting a light source 1006, and the adjustment of sight reticle is able to be achieved by adjusting upper, lower, left and right positions of the light source mounting seat 5. The UP adjusting mechanism 1 is able to move in the vertical direction, the UP adjusting mechanism 1 is able to be used for driving the light source mounting seat 5 to move upwards, the UP resetting mechanism 2 is able to be used for resisting an upward movement of the light source mounting seat 5, and the UP resetting mechanism 2 is able to be used for driving the light source mounting seat 5 to move downwards to be reset. A function of the R adjusting mechanism 3 is similar to a function of the UP adjusting mechanism 1, but the R adjusting mechanism 3 is arranged on the left side or right side of the light source mounting seat 5 to drive the light source mounting seat 5 to move in the horizontal direction. A function of the R resetting mechanism 4 is similar to a function of the UP resetting mechanism 2, but the R resetting mechanism 4 is arranged on the other side of the R adjusting mechanism 3 relative to the light source mounting seat 5 to resist the relative horizontal movement of the light source mounting seat 5 under an action of the R adjusting mechanism 3, so that the light source mounting seat 5 is able to be horizontally reset. In some embodiments, when the R adjusting mechanism 3 is arranged on the left side of the light source mounting seat 5, the R resetting mechanism 4 is arranged on the right side of the light source mounting seat 5. The inventive point of the present disclosure is that regardless of whether the light source mounting seat 5 actively adjusts the position in the vertical direction under the action of the UP adjusting mechanism 1 or passively deviates in the vertical direction under the action of the R adjusting mechanism 3 and the R resetting mechanism 4, the UP resetting mechanism 2 is able to ensure that the light source mounting seat 5 does not jump in the vertical direction. Similarly, the R resetting mechanism 4 is also able to ensure that the light source mounting seat 5 does not jump in the horizontal direction when the light source mounting seat 5 actively adjusts the position in the horizontal direction or passively deviates in the horizontal direction, thereby improving the reticle adjusting precision and efficiency.

In some embodiments, a first limiting part 61 is arranged at an end of the R adjusting mechanism 3, a second limiting part 62 and a third limiting part 63 are arranged at the two ends of the light source mounting seat 5 respectively, a fourth limiting part 64 is arranged at an end of the R resetting mechanism 4, the first limiting part 61 and the second limiting part 62 are limited in an abutting mode, and the third limiting part 63 and the fourth limiting part 64 are limited in an abutting mode, wherein the second limiting part 62 and the third limiting part 63 are symmetrically arranged at two ends of the mounting seat 5 of the light source 1006, the second limiting part 62 and the third limiting part 63 are respectively provided with a mounting hole, two UP adjusting mechanisms 1 are provided, and each of the two UP adjusting mechanism 1 is connected with the light source mounting seat 5 in an inserted mode through the mounting hole. The first limiting part 61 is matched with the second limiting part 62 to provide a guiding role when the R adjusting mechanism 3 adjusts the position in the horizontal direction for the light source mounting seat 5, thereby reducing a deviation of the light source mounting seat 5. Similarly, the third limiting part 63 is matched with the fourth limiting part 64 to provide a certain guiding role when the R resetting mechanism 4 provides reset to the light source mounting seat 5, thereby reducing the deviation of the light source mounting seat 5. Specifically, the R adjusting mechanism 3 and the R resetting mechanism 4 are respectively arranged on the left and right sides of the light source mounting seat 5 to together achieve the position adjustment of the light source mounting seat 5 in left and right directions. In some embodiments, the second limiting part 62 and the third limiting part 63 are both protrusions, and the first limiting part 61 and the fourth limiting part 64 are both grooves matched with the protrusions. In some embodiments, the protrusions have arc-shaped structures, the grooves are also arc-shaped grooves, the second limiting part 62 and the third limiting part 63 are symmetrically arranged about a geometric center of the mounting seat 5 of the light source 1006, and a size of the second limiting part 62 is the same as a size of the third limiting part.

In some embodiments, the R adjusting mechanism 3 includes an R adjusting screw 31 and an R adjusting slider 32, the R adjusting screw 31 is horizontally arranged and is in threaded connection with the R adjusting slider 32, and the first limiting part 61 is located on the R adjusting slider 32. In this embodiment, the R adjusting mechanism 3 and the R resetting mechanism 4 are respectively located on the horizontal left and right sides of the light source mounting seat 5, the R adjusting slider 32 is provided with a threaded hole, and the R adjusting screw 31 passes through the threaded hole and is in threaded connection with the R adjusting slider 32. By rotating the R adjusting screw 31, the R adjusting slider is able to slide left and right along the horizontal direction, thereby achieving the reticle adjusting of the light source 1006 in the horizontal direction. When the R adjusting mechanism 3 is used for adjusting the light source mounting seat 5 in the horizontal direction, by the limiting of the first limiting part 61 and the second limiting part 62, the light source mounting seat 5 will not deviate in a front-and-back direction during a left-and-right movement. In this embodiment, the front-and-back direction or left-and-right direction is relative, the horizontal direction is divided into the front-and-back direction and the left-and-right direction, and the front-and-back direction is a direction perpendicular to the left-and-right direction. If the R adjusting mechanism 3 and the R resetting mechanism 4 are arranged in the left-and-right direction of the light source mounting seat 5, by the limiting of the first limiting part 61 and the second limiting part 62 and the limiting of the third limiting part 63 and the fourth limiting part 64, the light source mounting seat 5 does not deviate in the front-and-back direction during the left-and-right movement. Of course, the R adjusting mechanism 3 and the R resetting mechanism 4 may also be arranged in the front-and-back direction of the light source mounting seat 5, and each limiting part is able to ensure that the light source mounting seat 5 does not deviate in the left-and-right direction during the front-and-back movement.

In some embodiments, the R resetting mechanism 4 includes an R resetting slider 41 and two R resetting units which are symmetrically arranged on two sides of a horizontal central axis of the R resetting slider 41, each of the two R resetting unit includes at least one R resetting spring 42 and at least one R resetting spring sleeve 43, the at least one R resetting spring sleeve 43 sleeves an end of the at least one R resetting spring 42, and the at least one R resetting spring 42 is horizontally arranged on the R resetting slider 41. The at least one R resetting spring 42 is penetrated through the R resetting slider 41. When the R adjusting mechanism 3 drives the light source mounting seat 5 to move towards the direction of the R resetting mechanism 4, under an action of a recovery force of the R resetting spring 42, the light source mounting seat 5 is reset in a case that an emitter generates a recoil force. Furthermore, under the protection of the R resetting spring sleeves 43, mutual interference between the resetting springs during squeezing is able to be prevented, thereby preventing the adjusting precision and efficiency from being affected.

In some embodiments, each of the at least one UP adjusting mechanism 1 includes a UP adjusting screw 11, at least one bias mechanism 12 and a UP adjusting slider 13, the UP adjusting screw 11 is vertically arranged and is in threaded connection with the UP adjusting slider 13, the at least one bias mechanism 12 is perpendicular to the UP adjusting screw 11, and the bias mechanism 12 is movably disposed in the UP adjusting slider 13 in a penetrating manner. The UP adjusting screw 11 is connected with the UP adjusting slider 13 through threads. By rotating the UP adjusting screw 11, the UP adjusting slider 13 is able to slide up and down. The bias mechanism 12 is perpendicular to a movement direction of the UP adjusting slider 13, so that when the UP adjusting slider 13 slides up and down, a parallel state is able to be maintained; and when the recoil force generated by an emitter causes the deviation of the light source mounting seat 5 of the sight, the light source mounting seat 5 is reset.

In some embodiments, the UP adjusting screw 11 includes an adjusting seat 111, an adjusting screw rod 114, an elastic connecting piece and a gasket 115, the adjusting seat 111 sleeves an outside of the adjusting screw rod 114, the elastic connecting piece is penetrated between the adjusting seat 111 and the adjusting screw rod 114, and the gasket 115 sleeves the adjusting screw rod 114, wherein the elastic connecting piece includes a limiting nail 112 and a limiting spring 113 which are connected with each other, the limiting nail 112 and the limiting spring 113 are both mounted in the mounting hole of the adjusting screw rod 114, and then, the adjusting seat 111 is sleeved. A latch groove is designed inside the adjusting seat 111, the limiting nail 112 is provided with a latch, and the latch is clamped with the latch groove to prevent a relative rotation between the adjusting screw rod 114 and the adjusting seat 111, thereby avoiding the relative rotation between the adjusting screw rod 114 and the adjusting seat 111, which may affect the aiming precision, when an emitter vibrates, impacts or falls.

In some embodiments, the UP resetting mechanism 2 includes two UP resetting units which are symmetrically arranged on two sides of a longitudinal central axis of the light source mounting seat 5, each of the two UP resetting units includes at least one UP spring sleeve 21 and at least one UP resetting spring 22, the at least one UP spring sleeve 21 sleeves an end of the at least one UP resetting spring 22 correspondingly, and the at least one UP resetting spring 22 is vertically arranged on the light source mounting seat 5. The UP resetting units are penetrated in the light source mounting seat 5, and the two UP resetting units are also located on two sides of the UP adjusting mechanism 1. The UP resetting mechanism 2 is able to apply a downward pressure under the action of the UP resetting spring 22 to reset the light source mounting seat 5. Furthermore, under the protection of the UP spring sleeves 21, mutual interference between the UP resetting springs 22 during squeezing is able to be prevented, thereby preventing the adjusting precision and efficiency from being affected.

### Embodiment 2

This embodiment is an embodiment 2 of a reticle adjusting device of an inner red dot sight. This embodiment is similar to Embodiment 1, and the difference between this embodiment and Embodiment 1 is that the bias mechanism 12 is one of a spring, a rubber elastomer and an elastic bead. By an own elastic recovery force, the bias mechanism 12 is able to prevent the deviation of the light source mounting seat 5 in the horizontal direction when the UP adjusting screw 11 drives the UP adjusting slider 13 to move up and down.

### Embodiment 3

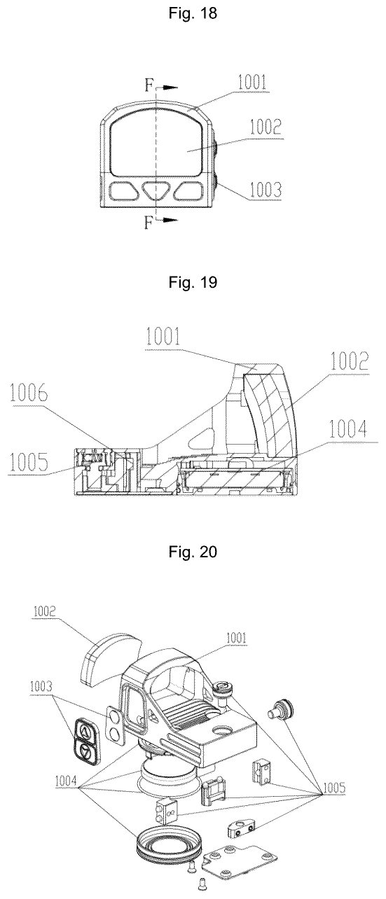

FIG. 17 to FIG. 20 show an embodiment of a sight, including a housing 1001, and an optical lens 1002, a light source 1006, a switch assembly 1003, a circuit driving assembly 1004 and the reticle adjusting device 1005 as described above, which are arranged on the housing 1001, wherein the optical lens 1002 is located at a front of the housing 1001, the light source 1006 is arranged in the reticle adjusting device 1005, the circuit driving assembly 1004 is connected with the switch assembly 1003, and the switch assembly 1003 is also electrically connected with the light source 1006.

In some embodiments, the light source 1006 is mounted on the light source mounting seat 5 in the reticle adjusting device 1005. After the light source 1006 is turned on, a reticle shape of a sight is formed and is reflected in parallel by the optical lens 1002 to enter the human eye, and at the same time, the human eye sees a target through the optical lens 1002. The reticle adjusting device 1005 is used for adjusting the light source mounting seat 5 so as to adjust the position of the light source 1006. When the reticle shape is overlapped with the target, the aiming is completed.

Obviously, the above embodiments of the present disclosure are only examples provided to clearly illustrate the present disclosure, and are not limitations on the implementations of the present disclosure. For those of ordinary skill in the art, other different forms of changes or modifications may also be made on the basis of the above explanation. It is not necessary and impossible to exhaustively list all implementations here. Any modifications, equivalent replacements, improvements and the like made within the spirit and principle of the present disclosure shall fall within the protection scope of the claims of the present disclosure.

1. A reticle adjusting device of an inner red dot sight, comprising:
a light source mounting seat;
at least one UP adjusting mechanism which is connected with or abuts against a bottom of the light source mounting seat and is used for adjusting the light source mounting seat to move upwards in a vertical direction;
a UP resetting mechanism which is movably connected with the light source mounting seat in an inserted mode and is used for enabling the light source mounting seat to move downwards to be reset in the vertical direction;
an R adjusting mechanism which is connected with the light source mounting seat and is used for adjusting the light source mounting seat to move leftwards or rightwards in a horizontal direction; and
an R resetting mechanism which is connected with the light source mounting seat and is used for enabling the light source mounting seat to move rightwards or leftwards to be reset in the horizontal direction,
wherein the R adjusting mechanism and the R resetting mechanism are arranged at two ends of the light source mounting seat respectively.

2. The reticle adjusting device of the inner red dot sight according to claim 1, wherein a first limiting part is arranged at an end of the R adjusting mechanism, a second limiting part and a third limiting part are arranged at the two ends of the light source mounting seat respectively, a fourth limiting part is arranged at an end of the R resetting mechanism, the first limiting part and the second limiting part are limited in an abutting mode, and the third limiting part and the fourth limiting part are limited in an abutting mode.

3. The reticle adjusting device of the inner red dot sight according to claim 2, wherein the R adjusting mechanism comprises an R adjusting screw and an R adjusting slider, the R adjusting screw is horizontally arranged and is in threaded connection with the R adjusting slider, and the first limiting part is located on the R adjusting slider.

4. The reticle adjusting device of the inner red dot sight according to claim 1, wherein the R resetting mechanism comprises an R resetting slider and two R resetting units which are symmetrically arranged on two sides of a horizontal central axis of the R resetting slider, each of the two R resetting units comprises at least one R resetting spring and at least one R resetting spring sleeve, the at least one R resetting spring sleeve sleeves an end of the at least one R resetting spring, and the at least one R resetting spring is horizontally arranged on the R resetting slider.

5. The reticle adjusting device of the inner red dot sight according to claim 1, wherein each of the at least one UP adjusting mechanism comprises a UP adjusting screw, at least one bias mechanism and a UP adjusting slider, the UP adjusting screw is vertically arranged and is in threaded connection with the UP adjusting slider, the at least one bias mechanism is perpendicular to the UP adjusting screw, and the at least one bias mechanism is movably disposed in the UP adjusting slider in a penetrating manner.

6. The reticle adjusting device of the inner red dot sight according to claim 5, wherein the UP adjusting screw comprises an adjusting seat, an adjusting screw rod, an elastic connecting piece and a gasket, the adjusting seat sleeves an outside of the adjusting screw rod, the elastic connecting piece is penetrated between the adjusting seat and the adjusting screw rod, and the gasket sleeves the adjusting screw rod.

7. The reticle adjusting device of the inner red dot sight according to claim 5, wherein the at least one bias mechanism is one of a spring, a rubber elastomer and an elastic bead.

8. The reticle adjusting device of the inner red dot sight according to claim 1, wherein the UP resetting mechanism comprises two UP resetting units which are symmetrically arranged on two sides of a longitudinal central axis of the light source mounting seat, each of the two UP resetting units comprises at least one UP spring sleeve and at least one UP resetting spring, the at least one UP spring sleeve sleeves an end of the at least one UP resetting spring correspondingly, and the at least one UP resetting spring is vertically arranged on the light source mounting seat.

9. The reticle adjusting device of the inner red dot sight according to claim 2, wherein the second limiting part and the third limiting part are symmetrically arranged at the two ends of the light source mounting seat, the second limiting part and the third limiting part are respectively provided with a mounting hole, two UP adjusting mechanisms are provided, and the two UP adjusting mechanisms are connected with the light source mounting seat in an inserted mode through the mounting hole.

10. The reticle adjusting device of the inner red dot sight according to claim 1, wherein the second limiting part and the third limiting part are both protrusions, and the first limiting part and the fourth limiting part are both grooves matched with the protrusions.

11. The reticle adjusting device of the inner red dot sight according to claim 10, wherein a first limiting part is arranged at an end of the R adjusting mechanism, a second limiting part and a third limiting part are arranged at the two ends of the light source mounting seat respectively, a fourth limiting part is arranged at an end of the R resetting mechanism, the first limiting part and the second limiting part are limited in an abutting mode, and the third limiting part and the fourth limiting part are limited in an abutting mode.

12. The reticle adjusting device of the inner red dot sight according to claim 11, wherein the R adjusting mechanism comprises an R adjusting screw and an R adjusting slider, the R adjusting screw is horizontally arranged and is in threaded connection with the R adjusting slider, and the first limiting part is located on the R adjusting slider.

13. The reticle adjusting device of the inner red dot sight according to claim 10, wherein the R resetting mechanism comprises an R resetting slider and two R resetting units which are symmetrically arranged on two sides of a horizontal central axis of the R resetting slider, each of the two R resetting units comprises at least one R resetting spring and at least one R resetting spring sleeve, the at least one R resetting spring sleeve sleeves an end of the at least one R resetting spring, and the at least one R resetting spring is horizontally arranged on the R resetting slider.

14. The reticle adjusting device of the inner red dot sight according to claim 10, wherein each of the at least one UP adjusting mechanism comprises a UP adjusting screw, at least one bias mechanism and a UP adjusting slider, the UP adjusting screw is vertically arranged and is in threaded connection with the UP adjusting slider, the at least one bias mechanism is perpendicular to the UP adjusting screw, and the at least one bias mechanism is movably disposed in the UP adjusting slider in a penetrating manner.

15. The reticle adjusting device of the inner red dot sight according to claim 14, wherein the UP adjusting screw comprises an adjusting seat, an adjusting screw rod, an elastic connecting piece and a gasket, the adjusting seat sleeves an outside of the adjusting screw rod, the elastic connecting piece is penetrated between the adjusting seat and the adjusting screw rod, and the gasket sleeves the adjusting screw rod.

16. The reticle adjusting device of the inner red dot sight according to claim 15, wherein the at least one bias mechanism is one of a spring, a rubber elastomer and an elastic bead.

17. The reticle adjusting device of the inner red dot sight according to claim 10, wherein the UP resetting mechanism comprises two UP resetting units which are symmetrically arranged on two sides of a longitudinal central axis of the light source mounting seat, each of the two UP resetting units comprises at least one UP spring sleeve and at least one UP resetting spring, the at least one UP spring sleeve sleeves an end of the at least one UP resetting spring correspondingly, and the at least one UP resetting spring is vertically arranged on the light source mounting seat.

18. The reticle adjusting device of the inner red dot sight according to claim 11, wherein the second limiting part and the third limiting part are symmetrically arranged at the two ends of the light source mounting seat, the second limiting part and the third limiting part are respectively provided with a mounting hole, two UP adjusting mechanisms are provided, and the two UP adjusting mechanisms are connected with the light source mounting seat in an inserted mode through the mounting hole.

19. A sight, comprising a housing, and an optical lens, a light source, a switch assembly, a circuit driving assembly and the reticle adjusting device according to claim 1, which are arranged on the housing, wherein the optical lens is located at a front of the housing, the light source is arranged in the reticle adjusting device, the circuit driving assembly is connected with the switch assembly, and the switch assembly is also electrically connected with the light source.
